(19) United States
(12) Patent Application Publication
(10) Pub. No.: US 2025/0170965 A1
(43) Pub. Date: May 29, 2025

(54) MODULAR TRUCK BED ORGANIZER

(71) Applicants: Douglas G. Rich, Sayre, PA (US); Luanne K. Rich, Sayre, PA (US)

(72) Inventors: Douglas G. Rich, Sayre, PA (US); Luanne K. Rich, Sayre, PA (US)

(21) Appl. No.: 18/960,925

(22) Filed: Nov. 26, 2024

Related U.S. Application Data
(60) Provisional application No. 63/602,844, filed on Nov. 27, 2023.

(51) Int. Cl. B60R 9/06; B60R 5/04

(52) U.S. Cl. CPC B60R 9/06; B60R 5/041

(57) ABSTRACT

Disclosed herein are devices relating to a modular truck bed organizer. The contemplated truck bed organizer may have one or more cargo receptacles capable of easily sliding to provide easier access and greater stability for items placed in the truck bed. The design does not require significant adaptations to be made to the truck bed for installation and minimizes its own size in order to maximize the available cargo area.

### CLAIM OF PRIORITY

This application claims priority to Provisional Patent Application Ser. No. 63/602,844 filed on Nov. 27, 2023, the entirety of which is hereby incorporated by reference.

### BACKGROUND OF THE DISCLOSURE

The present disclosure relates to a modular truck bed organizer.

Pickup trucks offer the advantage of significant storage availability provided by their truck beds. This advantage comes with the drawback that items placed in the truck bed may be difficult to reach and keep secure. Traditionally a person may have to physically climb into the bed to reach items placed in the bed. Some trucks may include a step, in order to make it easier to climb into the bed.

Other systems provide ways to move the items placed in the bed without having to climb into the bed. Such systems may often include drawers or other types of sliding platforms. These systems often require significant hardware attachment that may cause permanent changes to be made to the truck or its bed. These systems also often significantly reduce the cargo area of the truck bed. As such, a simple and size effective means of organizing and accessing items in a truck bed is desirable. Also, it is desirable to provide an organizer which provides divider walls which are collapsible so that the truck bed can be used with the divider walls in a horizontal position.

Accordingly, there is a need for a modular truck bed organizer which is collapsible and overcomes the above mentioned difficulties and others while providing better overall results.

### BRIEF DESCRIPTION OF THE DISCLOSURE

This disclosure relates to a modular truck bed organizer.

Make particularly, accordance with one aspect of the disclosure, the modular truck bed organizer may include only one cargo receptacle. In accordance with another aspect of the disclosure, the modular truck bed organizer may include multiple cargo receptacles. The one or more cargo receptacles may interact with one or more sliding rails placed in the truck bed in order to allow the cargo receptacles to slide and provide easy access.

In other embodiments a tether connects the truck and cargo receptacle so that the cargo receptacle can not slide too far.

In some embodiments the sliding rails include a plurality of rollers or ball bearings to reduce the friction between the sliding rail and the cargo receptacle.

In other embodiments the sliding rails include felt to reduce the friction between the sliding rail and the cargo receptacle.

In certain embodiments a guide may constrain the movement of one or more cargo receptacles. One or more spacer guides may also be particularly shaped to fit in a truck bed's geometry and restrict the movement of a cargo receptacle.

In some embodiments one or more cargo receptacles may include an insert particularly designed to hold certain types of cargo.

According to one aspect of the disclosure, sliding rails and guides are removably positioned on the truck bed.

According to another aspect of the disclosure, divider walls are collapsible so the truck bed may be used without vertical dividers.

According to another aspect of the disclosure, the cargo receptacles may hold one or more of the following: golf clubs, fishing rods, skis, sports equipment, tools, lawn equipment, etc.

Still other aspects of the disclosure will become apparent upon a reading and understanding of the following detailed description.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a rear perspective view of a truck with the guide and sliding rails with rollers placed in the truck bed in accordance with a preferred embodiment of the disclosure.

FIG. 1A is a side cross-sectional view of a ball bearing roller arrangement of FIG. 1.

FIG. 2 is a rear perspective view of a truck with a cargo receptacle placed on top of sliding rails and between a guide and spacer guide in accordance with an embodiment of the disclosure.

FIG. 3 is a rear perspective view of a truck with sliding rails with felt placed in the truck bed in accordance with an embodiment of the disclosure.

FIG. 3A is a side cross-sectional view of felt strips for the system of FIG. 3.

FIG. 4 is a rear perspective view of a truck with two cargo receptacles in a collapsed position and in place in the truck bed in accordance with the embodiment of the disclosure.

FIG. 5 is a rear perspective view of a truck showing a cargo receptacle insert in one of the cargo receptacles in accordance with an embodiment of the disclosure.

FIG. 6 is a rear perspective view of a truck with a tether connecting the truck to the cargo receptacle in accordance with an embodiment of the disclosure.

FIG. 7 is a perspective view of a truck bed organizer with a center divider and rails in accordance with another aspect of the disclosure.

FIG. 8 is a perspective view of a pair of truck beds with a center divider of FIG. 7. FIG. 9 is an enlarged perspective view of rollers in the rails of FIG. 8.

FIG. 10 is a cross sectional view of the rollers and rail system of FIG. 9.

### DETAILED DESCRIPTION OF THE DISCLOSURE

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

The term “comprising” is used herein as requiring the presence of the named components/steps and allowing the presence of other components/steps. The term “comprising” should be construed to include the term “consisting of”, which allows the presence of only the named components/steps.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

A value modified by a term or terms, such as “about” and “substantially,” may not be limited to the precise value specified. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number.

The terms “top” or “upper” and “bottom” or “lower” are used to refer to locations/surfaces where the top/upper is always higher than the bottom I lower relative to an absolute reference, i.e. the surface of the earth. The terms “upwards” and “downwards” are also relative to an absolute reference; upwards is always against the gravity of the earth.

The terms “horizontal” and “vertical” are used to indicate direction relative to an absolute reference, i.e. ground level. However, these terms should not be construed to require structures to be absolutely parallel or absolutely perpendicular to each other. For example, a first vertical structure and a second vertical structure are not necessarily parallel to each other.

The present disclosure relates a modular truck bed organizer. The contemplated truck bed organizer allows for the entire or only a portion of the truck bed to become a slidable organizer. The contemplated truck bed organizer minimizes the space it takes up in the bed in order to maximize the cargo space available.

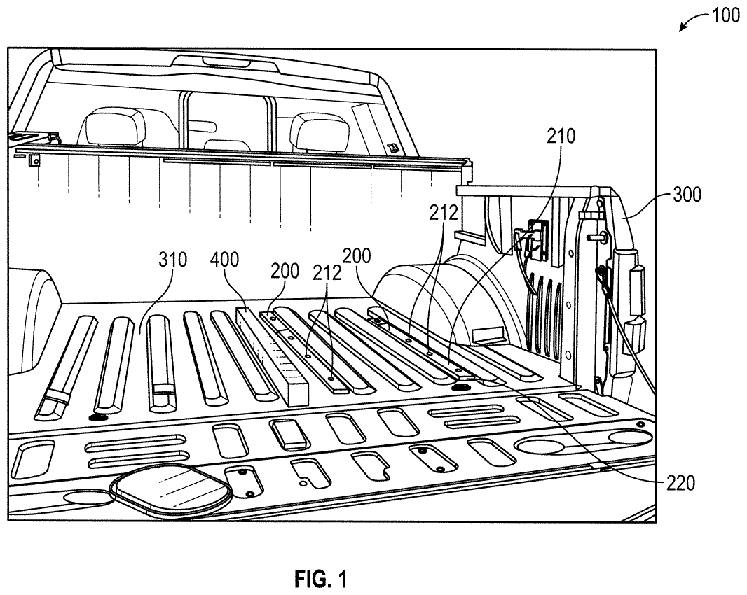

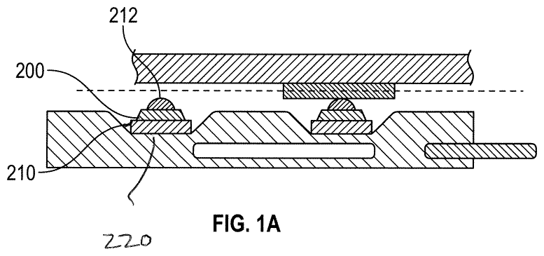

In accordance with a preferred embodiment of the disclosure, FIG. 1 is a rear perspective view of a truck 300 with a portion of the truck bed organizer 100 in place in the truck bed 310. Two parallel sliding rails 200 can be seen placed in the truck bed 310 along a longitudinal axis of the truck bed 310. The rails 200 are removably positioned on the truck bed. The sliding rails can be seen to have a cargo (upper) side 210 and a truck bed (lower) side 220. As shown the truck bed side 220 of the sliding rail 210 contacts the truck bed 310. The cargo side 210 of the sliding rail 200 can be seen with a plurality of rollers or stainless ball bearings 212 or nylon glides (see FIG. 1A). A guide 400 can also be seen placed in the truck bed 310 which helps align the cargo receptacle 500 on the rails. The guide is also removably positioned on the truck bed.

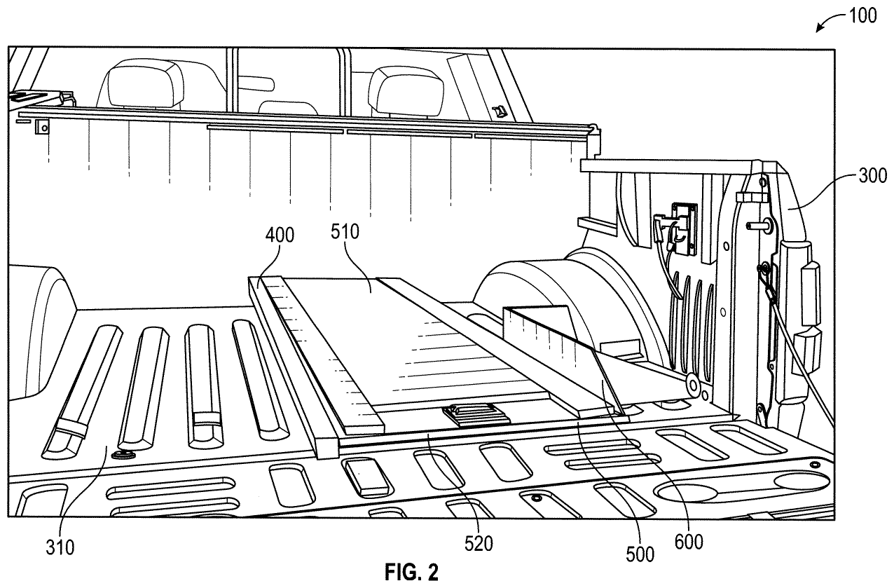

FIG. 2 is a rear perspective view of a truck 300 with an embodiment of the truck bed organizer 100 in place. The cargo receptacle 500 can be seen with a cargo (upper) side 51O and a truck bed (lower) side 520. A guide 400 can again be seen in the truck bed 310. A spacer guide 600 can be seen in the truck bed 310. The spacer guide 600 can be adapted to different truck bed 310 geometries. In this embodiment the spacer guide 600 is adapted to fit in a pocket of the truck bed 310 caused by the wheel well. The guide 400 and the spacer guide 600 work together to restrict lateral movement of the cargo receptacle 500 in the truck bed.

Referring to FIGS. 1-2 together, a user may pull the cargo receptacle 500 in its longitudinal direction. The truck bed side 520 of the cargo receptacle may interact with the plurality of rollers 212 on the cargo side 210 of the sliding rails 200. Such interaction provides reduced friction and allows the cargo receptacle 500 to be easily slid. The guide 400 and spacer guide 600 restrict the cargo receptacle's lateral movement so that it only slides in its longitudinal direction towards and away from the truck bed.

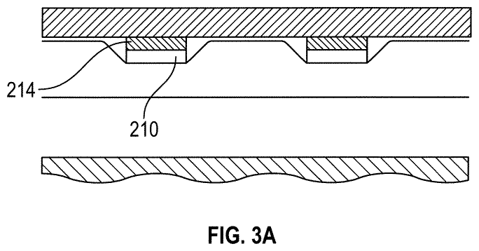

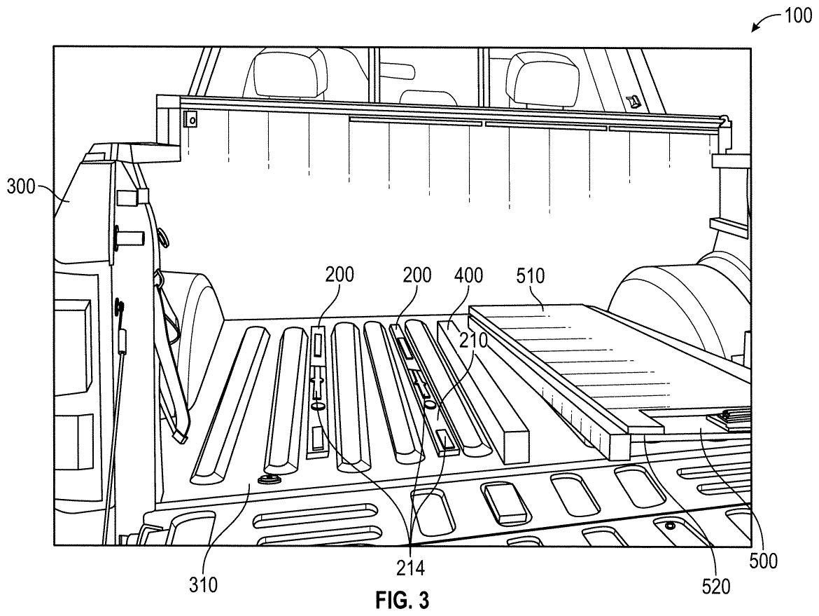

FIG. 3 is a rear perspective view of a truck 300 with the truck bed organizer 100 of FIGS. 1-2 in place. Also shown are additional sliding rails 200. These additional sliding rails 200 include felt strips 214 or similar material on their cargo (upper) side 210 (See also FIG. 3A).

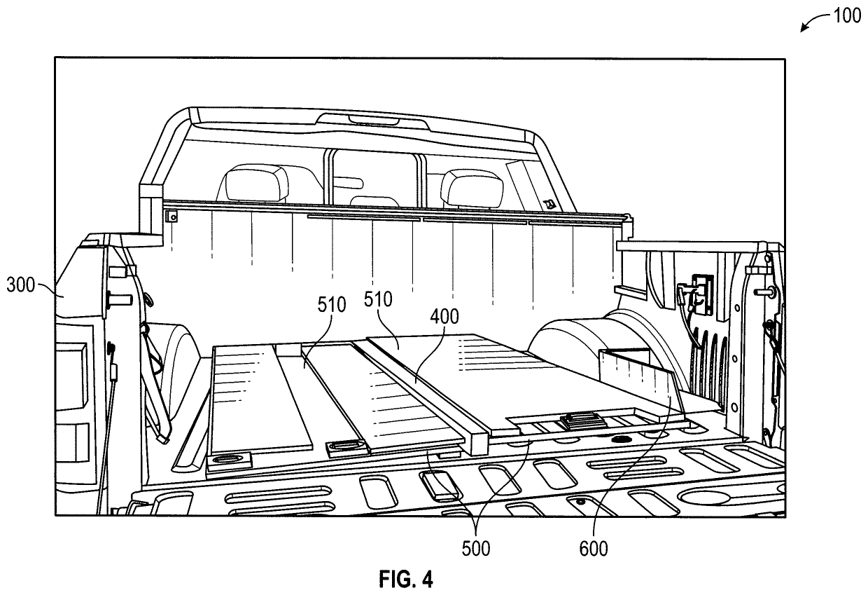

FIG. 4 is a rear perspective view of a truck 300 with an embodiment of the truck bed organizer 100 with two cargo receptacles 500 in the collapsed position. The two cargo receptacles 500 are separated by a centrally positioned guide 400. One or more spacer guides 600 may be used to restrict the cargo receptacle's lateral movement.

Referring to FIGS. 3-4 together, a user may pull the cargo receptacle 500 in its longitudinal direction away from the truck bed and push the cargo receptacle towards the truck bed. The truck bed side 520 of the cargo receptacle may interact with the felt strips or bearings 214 on the cargo side 210 of the sliding rails 200. Such interaction provides reduced friction and allows the cargo receptacle 500 to be easily slid into and out of the truck bed.

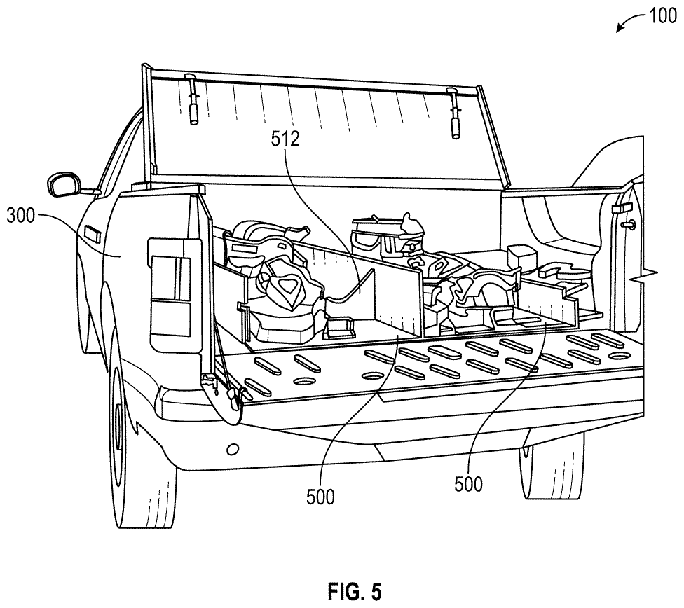

FIG. 5 is a rear perspective of a truck 300 showing an embodiment of a cargo receptacle 500 with a cargo receptacle insert 512. The cargo receptacle insert 512 may be adapted in order to accommodate particular types of cargo. The shown cargo receptacle insert 512 is adapted to accommodate golf clubs. The cargo insert may have partitions and walls to form several compartments in the insert. For example, other items, such as tools, fishing rods, lawn equipment and skis and other sporting items can be accommodated in the compartments.

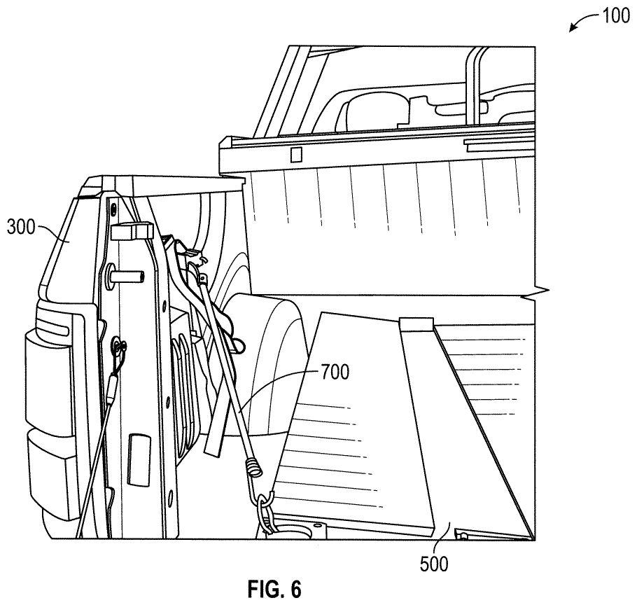

FIG. 6 is a rear perspective view of a truck 300 with an embodiment of the contemplated truck organizer 100 in place. A tether 700 is shown connecting the truck 300 and a cargo receptacle 500. The tether 700 limits how far the cargo receptacle 500 can slide. In some embodiments the tether 700 may be retractable.

Referring to all figures together, it can be seen that a user may choose to create a truck bed organizer 100 with one or multiple cargo receptacles 500.

In creating a truck bed organizer with only one cargo receptacle 500 the user can place a guide 400 in the center of the truck bed 310. In some embodiments the guide 400 may simply fit in the geometry of the truck bed 310 while in other embodiments the guide 400 may be affixed to the truck bed 310. The user may then place one or more sliding rails 200 in the truck bed 310. In some embodiments the sliding rails may simply fit in the geometry of the truck bed 310 while in other embodiments the sliding rails 200 may be affixed to the truck bed 310. A cargo receptacle may then be placed on the one or more sliding rails 200 and a spacer guide 600 may be placed in the truck bed 310. A tether 700 may be connected to the truck 300 and cargo receptacle 500. A user can then pull the cargo receptacle 500 in its longitudinal direction, while the guide 400 and spacer guide 600 restrict the cargo receptacle's 500 transverse movement. The tether 700 restricts how far the cargo receptacle 500 can slide over the one or more sliding rails 200.

In creating a truck bed organizer with two cargo receptacles 500 the user can place a guide 400 in the center of the truck bed 310. In some embodiments the guide 400 may simply fit in the geometry of the truck bed 310 while in other embodiments the guide 400 may be affixed to the truck bed 310. The user may then place one or more sliding rails 200 in the truck bed 310 on each side of the guide 400. In some embodiments the sliding rails may simply fit in the geometry of the truck bed 310 while in other embodiments the sliding rails 200 may be affixed to the truck bed 310. A cargo receptacle may then be placed on each side of the guide 400 over the one or more sliding rails 200 and one or more spacer guides 600 may be placed in the truck bed 310. One or more tethers 700 may be connected to the truck 300 and each cargo receptacle 500. A user can then pull a cargo receptacle 500 in its longitudinal direction, while the guide 400 and spacer guide 600 restrict the cargo receptacle's 500 transverse movement. The tether 700 restricts how far the cargo receptacle 500 can slide over the one or more sliding rails 200.

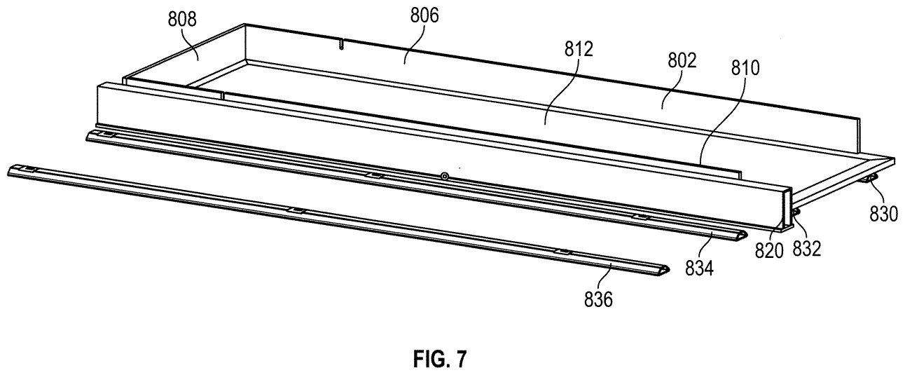

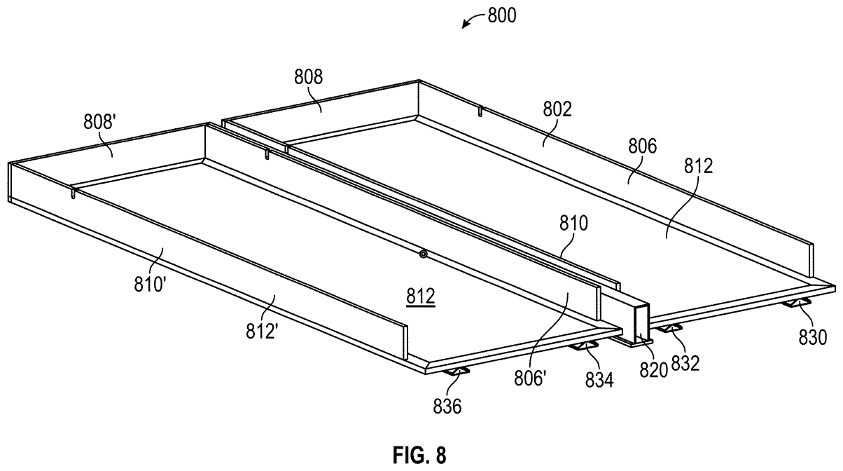

Referring to FIGS. 7-10, another embodiment of a truck bed organizer 800 is shown. The organizer 800 has two cargo receptacles 802, 804 each having three side walls 806, 806′, 808, 808′, 810, 810′ and a bottom wall 812, 812′. The bottom walls 812, 812′ each have an upper cargo side and a lower truck bed side. A center divider wall 820 is positioned longitudinally between parallel cargo receptacles 802, 804. Each of the receptacles 802, 804 is placed on a pair of sliding rails 830, 832, 834, 836 which are positioned on the truck bed. That is, the truck bed side of the bottom walls 812, 812′ are placed on the rails.

Referring to FIG. 9, the rails each have roller bearings 840 which extends through an opening 842 in a roller mount 850 formed in upper wall 844. The sliding rails may be fabricated from an aluminum extrusion, while the rollers are made of urethane rubber with a sealed bearing. The roller mount 850 may be made of plastic or metal.

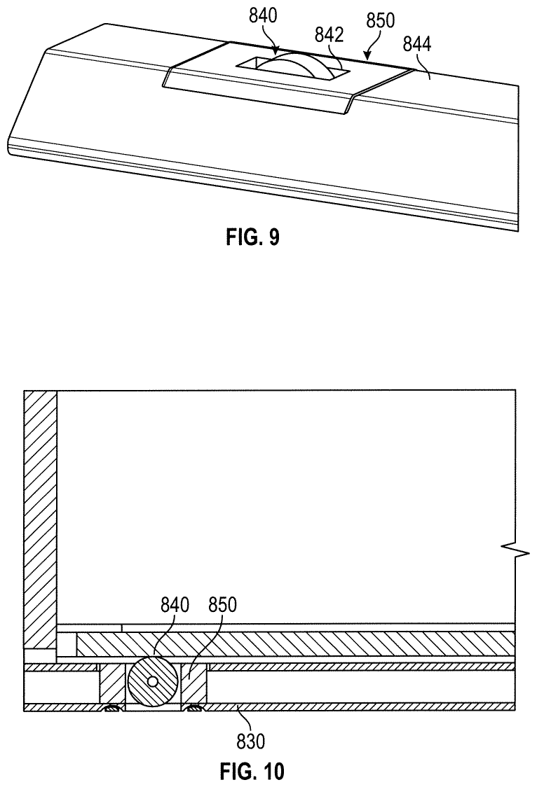

Referring to FIG. 10, a cross-sectional view of the rollers 840 and roller mounts 850 is shown positioned below the bottom wall of the cargo receptacles. The receptacles slide or roll along the rollers into and out of the truck bed.

Referring to FIGS. 1A, 3A and 10, various bearing elements are available for different applications for the truck bed organizer; i.e. ball bearings 212 (FIG. 1A), felt bearings 214 (FIG. 3A) and roller bearings 840 (FIG. 10).

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. A truck bed organizer, comprising:
at least one cargo
receptacle; a guide; and
at least one sliding rail; wherein said cargo receptacle, said configured guide and said sliding rail are configured to be positioned within an associated truck bed.

2. The truck bed organizer of claim 1, wherein the guide is specifically adapted to the geometry of the truck bed.

3. The truck bed organizer of claim 1, wherein the guide is removably positioned on a truck bed.

4. The truck bed organizer of claim 1, wherein the at least one sliding rail is specifically configured to the geometry of a truck bed.

5. The truck bed organizer of claim 1, wherein the at least one sliding rail is removably positioned to the truck bed.

6. The truck bed organizer of claim 1, further comprising at least one spacer guide.

7. The truck bed organizer of claim 6, wherein the at least one spacer guide is specifically configured to the geometry of a truck bed.

8. The truck bed organizer of claim 1, further comprising at least one tether.

9. The truck bed organizer of claim 8, wherein the tether is retractable.

10. The truck bed organizer of claim 8, wherein the at lest one tether operatively connects the at least one cargo receptacle and a truck.

11. The truck bed organizer of claim 10, wherein the tether limits the at least one cargo receptacle's movement.

12. The truck bed organizer of claim 1, wherein the at least one cargo receptacle comprises:
a cargo side;
and a truck
bed side.

13. The truck bed organizer of claim 12, wherein the at least one sliding rail comprises two sliding rails each having:
a cargo side;
and a truck
bed side.

14. The truck bed organizer of claim 13, wherein the truck bed side of the at least one cargo receptacle contacts the cargo side of the two sliding rails.

15. The truck bed organizer of claim 14, wherein the contact between the truck bed side of the at least one cargo receptacle and the cargo side of the two sliding rails has a low friction interaction.

16. The truck bed organizer of claim 14, wherein the truck bed side of the two sliding rails contact a truck bed.

17. The truck bed organizer of claim 16, wherein the friction between the truck bed side of the two sliding rails and the truck bed is greater than the friction between the truck bed side of the at least one cargo receptacle and the cargo side of the two sliding rails.

18. The truck bed organizer of claim 16, wherein each of the two sliding rails comprises:
a plurality of rollers.

19. The truck bed organizer of claim 18, wherein the plurality of rollers extend from roller mounts on the cargo side of the two sliding rails.

20. The truck bed organizer of claim 19, wherein the truck bed side of the cargo receptacle contacts the plurality of rollers.

21. The truck bed organizer of claim 16, wherein each cargo side of the two sliding rails is covered in felt.

22. The truck bed organizer of claim 21, wherein the truck bed side of the cargo receptacle contacts the felt of the two sliding rails.

23. A truck bed organizer, comprising:
at least one cargo receptacle,
comprising: a cargo side, and
a truck bed side;
a guide;
at least one sliding rail, comprising:
a cargo side, and
a truck bed side;
at least one
spacer guide;
a tether, the tether operatively connecting the at least one cargo receptacle and a truck.

24. The truck bed organizer of claim 23, where said at least one cargo receptacle is configured to hold one of the following: golf clubs, fishing rods, skis, tools, and lawn equipment.
